(19) United States
(12) Patent Application Publication
(10) Pub. No.: US 2004/0113897 A1
(43) Pub. Date: Jun. 17, 2004

(54) A device which replaces the antenna of a wireless communication device with a writing instrument that still may function as an antenna

(76) Inventor: Robert Darren Brumfield, Las Vegas, NV (US)

Correspondence Address: ROBERT DARREN BRUMFIELD, C/O 4817 PRIME COURT, LAS VEGAS, NV, 89130, US

(21) Appl. No.: 10/707,475

(22) Filed: Dec. 17, 2003

Related U.S. Application Data
(60) Provisional application No. 60/319,794, filed on Dec. 17, 2002.

(51) Int. Cl. G09G 5/00

(52) U.S. Cl. 345/179

(57) ABSTRACT

A device which is attached to a cellular phone that may or may not replace the antenna and may or may not function as an antenna, that is primarily used for writing, marking, or pointing electronically. The device is designed to be easily accessible at all times when one has a cellular telephone or other wireless communication device. At the present time the embodiment of the device is for use as a writing instrument that leaves visible markings on any suitable surface such as a piece of paper. The future implementation of this device is as a stylus or pointer for the input of information from a user to a cellular telephone when our technology advances to that point.

### BACKGROUND OF INVENTION

There are times when a writing instrument is needed and one can not be found. This usually occurs away from the home or office. People carry their cellular phones with them everywhere they go and if these people had this device the problem would be solved. People who have been in this situation know that a need exists for this invention.

### SUMMARY OF INVENTION

This invention solves the problem of not having something to write with when you need one by replacing the standard antenna on a cellular phone with a slim writing instrument that slides out of the phone just like an antenna. The attachment point for the antenna base makes a grip to hold the writing instrument.

The writing instrument has a metal body so it will still function as an antenna. The dry medium form of this device uses lead from a mechanical pencil. The wet medium form uses a ball point pen type ink pen or a fine line fiber tip ink pen with a narrow reservoir. The non-marking form of this device will simply be a point that functions as a stylus or pointer for a future cellular telephone based device that hasn't been invented yet but is certainly on the horizon due to miniaturization of electronics today.

The dimensions of these devices will fit within the dimensions of the cellular phone antennae that they replace and the thread sizes of the threaded bodies will match the thread sizes of the cellular phone antennae attachment holes.

The device could have a writing instrument on both ends, such as a wet medium tip on one end and a stylus or pointer on the other end. This is a design visualization that the market may or may not need. The main idea is to make an antenna replacement for cellular phones with which one may write or in the case of electronics usage, point. It doesn't necessarily have to be removed to use, but that is an option.

### BRIEF DESCRIPTION OF DRAWINGS

Although these drawings are presented as an attempt to visually describe this invention they are in no way definitive of the final result of engineering, market study, or revision to said invention. All drawings represent one of many possible configurations for this device and the scope of these drawings shall in no way limit the device that originated them.

The drawings included in this application illustrate a method of implementing this device and its use.

### DETAILED DESCRIPTION

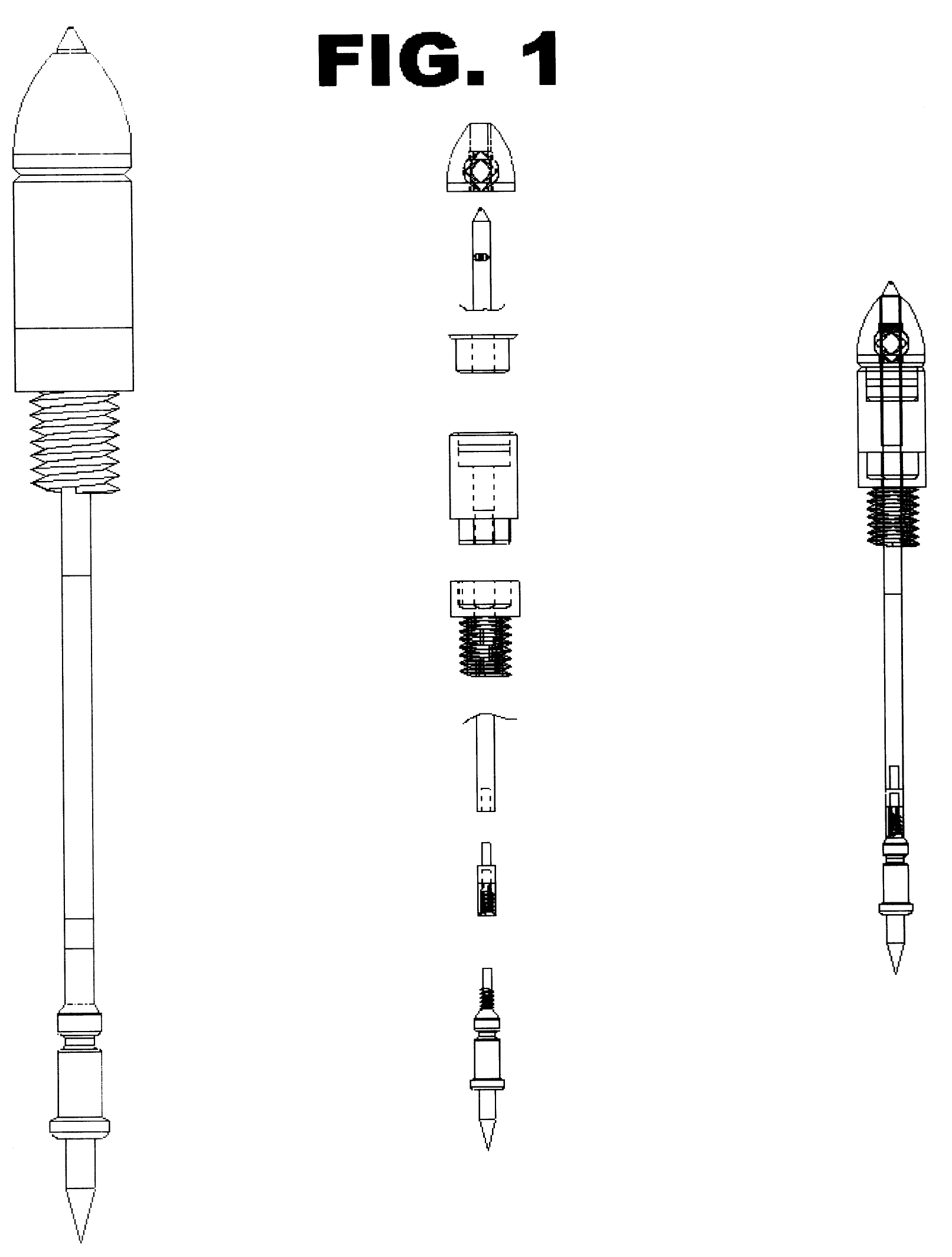

FIG. 1 illustrates an embodiment of this invention in 3 views. The left view shows the outside only. The center view shows the parts exploded in line, with the hidden interior lines drawn as dashes. The right view shows all lines both inside and out.

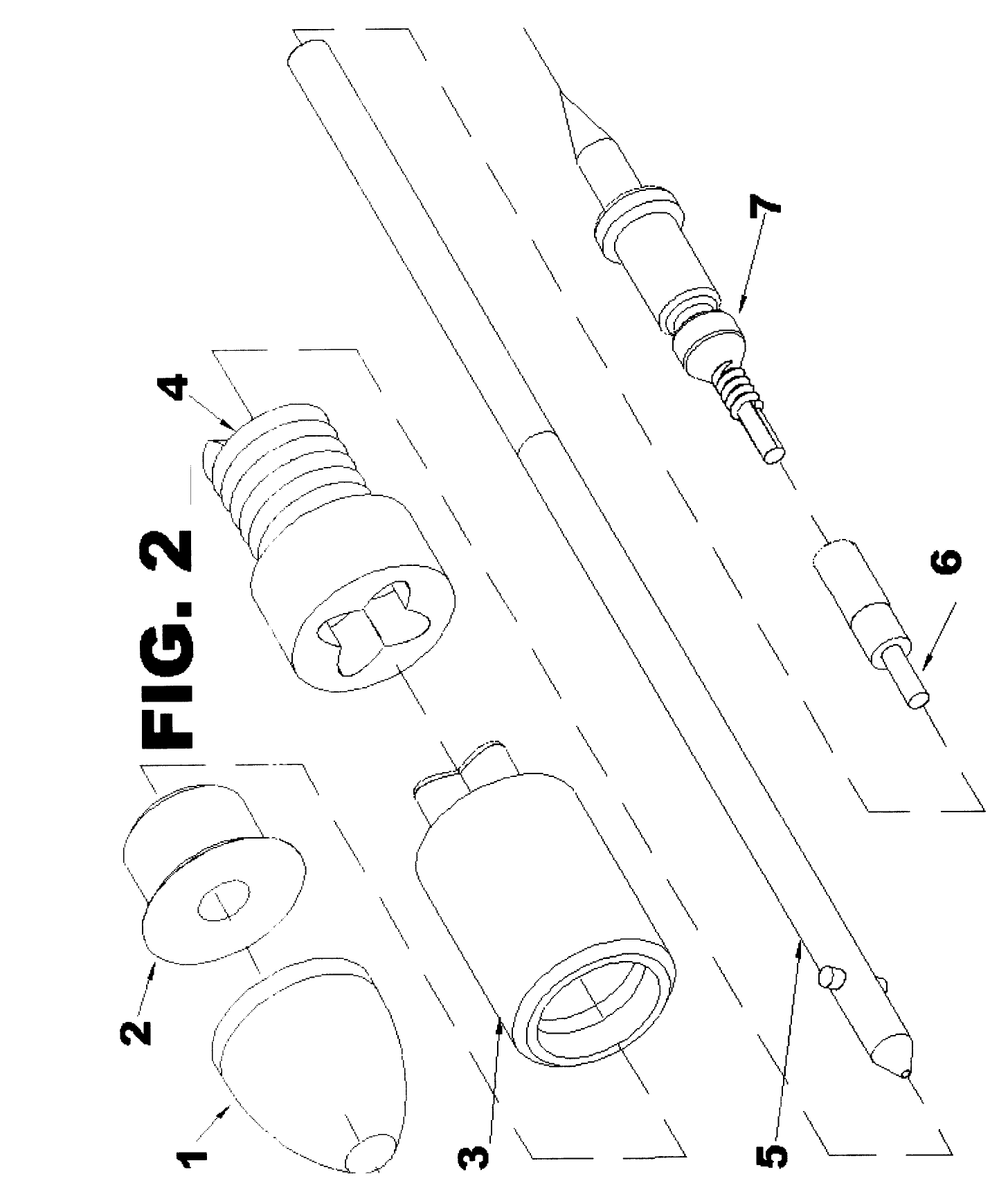

FIG. 2 is an isometric exploded view of the device with the parts arranged on a centerline in the order of assembly. The parts are described as follows:

PART 1 is a conically shaped piece which extends and retracts the writing end of the writing instrument/antenna (hereinafter referred to as “writing antenna”) via a swivel motion that is created be a helically shaped groove that mates to the dowels of PART 5.

PART 2 is piece that mates to PART 1 and facilitates the manufacture of this invention because of the helically shaped groove contained in PART 1. PART 2 mates to PART 3 via a tolerance fit.

PART 3 acts as a grip to hold the writing antenna in hand when the invention is removed from the communication device. PART 3 fits into PART 4 via a tolerance fit.

PART 4 is used to attach this invention to the portable wireless communication device by means of a threaded connection. The thread size will match the various wireless communication device bodies for which this invention is designed.

PART 5 is the actual writing antenna itself. It is embodied as an ink pen in this drawing. The writing antenna should be pressurized and sealed to avoid leaking when it is used or stored. This seal is accomplished through the use of PART 6 or PART 7 depending on the method of manufacture.

PART 6 is press-fitted to PART 5 and acts as a seal to hold in the pressurized writing medium and acts as a mating surface for PART 7 by means of a threaded connection when PART 6 is necessary. PART 6 is necessary for refills. If a disposable writing antenna is manufactured then PART 6 isn't necessary.

PART 7 mates to either PART 6 or PART 5 depending on the application and is attached via a threaded connection or a press fit. PART 7 functions as a positive stop to hold the antenna in the extended position for better signal strength. The end of PART 7 is used as an electronic stylus tip or pointing device for touch screens and the like.

1. What is claimed is a writing instrument that has a stylus on one end and a marking nib on the other end such as an ink pen or mechanical pencil.

2. What is claimed is a combination writing instrument and antenna that is stored in or on, or attaches to a wireless communication device and the manufacture thereof.

3. What is claimed is a writing instrument that is stored in or on, or attaches to a wireless communication device.
